(19) United States
(12) Patent Application Publication
(10) Pub. No.: US 2026/0366814 A1
(43) Pub. Date: Nov. 19, 2026

(54) COMMODITY MANAGEMENT SYSTEMS AND RELATED METHODS AND SYSTEMS

(71) Applicant: GSI Electronique Inc, Saint-Hubert (CA)

(72) Inventors: William Kurt HILDEBRAND, Winnipeg (CA); Alvarim MARQUES DA COSTA, Saint-Hubert (CA); Bryan REIMER, Saint-Hubert (CA); Russell MILNE, Winnipeg (CA)

(73) Assignee: GSI Electronique Inc, Saint-Hubert, QC (CA)

(21) Appl. No.: 19/165,996

(22) PCT Filed: Jan. 8, 2024
(86) PCT No.: PCT/IB2024/050150

§ 371 Date: Sep. 16, 2025

(30) Foreign Application Priority Data
Mar. 17, 2023 (GB) 2303968.8

(51) Int. Cl. F26B 21/33; A01F 25/22; F26B 21/35; F26B 25/22

(52) U.S. Cl. CPC F26B 21/33; A01F 25/22; F26B 21/35; F26B 25/22; F26B 2200/06

(57) ABSTRACT

Methods of managing conditions of a commodity within a container. The method includes setting an operating moisture range for a commodity treatment device to be different from a target moisture range of the commodity, setting an operating temperature range for the commodity treatment device to be different from a target temperature range of the commodity, and powering on the commodity treatment device only when both a moisture content of air external to the container falls within the operating moisture range and a temperature of the air external to the container falls within the operating temperature range. Systems for managing conditions of a commodity within a container.

### FIELD

Embodiments generally relate to commodity (e.g., grain) monitoring and commodity management. In particular, embodiments relate to systems for and methods of managing conditions of a commodity via commodity treatment devices.

### BACKGROUND

In the monitoring of commodities within storage bins, it is important to monitor certain parameters to keep the stored commodities cool and dry. Based on the monitored parameters, determinations that the stored commodities need aeration, heating, and/or by churning may be made. In cable-based monitoring, parameters are typically monitored via sensor nodes suspended by cables. Furthermore, knowing the moisture content and temperature of the commodities is important in determining that the stored commodities need aeration, heating, and/or by churning.

### BRIEF SUMMARY

Some embodiments include a method of managing a commodity within a container. The method may include receiving first measurement data of the commodity and based at least partially on the first measurement data determining whether a moisture content of the commodity is within a target moisture range of the commodity, and determining whether a temperature of the commodity is within a target temperature range of the commodity. The method also includes, responsive to a determination that the moisture content of the commodity is above the target moisture range of the commodity or that the temperature of the commodity is above the target temperature range of the commodity, determining at least one of an operating moisture range for a commodity treatment device to be different than the target moisture range of the commodity or an operating temperature range for the commodity treatment device to be different from the target temperature range of the commodity. The method also includes receiving measurement data of an outside environment and responsive to a determination that an outside moisture content falls within the operating moisture range for the commodity treatment device and that an outside temperature falls within the operating temperature range for the commodity treatment device, causing the commodity treatment device to be powered on to treat the commodity.

Causing the commodity treatment device to be powered on may include causing at least one of a fan or a heater to be powered on.

Causing the commodity treatment device to be powered on may include causing at least one vent to be opened.

Determining the operating moisture range for the commodity treatment device to be different than the target moisture range of the commodity may include setting a lower bound of the operating moisture range to be lower than a lower bound of the target moisture range, and setting an upper bound of the operating moisture range to be equal to the moisture content of the commodity.

Determining the operating temperature range for the commodity treatment device to be different than the target temperature range of the commodity may include setting a lower bound of the operating temperature range to be lower than a lower bound of the target temperature range, and setting an upper bound of the operating temperature range to be equal to the temperature of the commodity.

The method may also include receiving second measurement data of the commodity and based at least partially on the second measurement data, determining whether the moisture content of the commodity is within the target moisture range of the commodity, and determining whether the temperature of the commodity is within the target temperature range of the commodity.

The method may also include receiving the target moisture range and the target temperature range via a user input.

A difference between the lower bound of the operating moisture range and the lower bound of the target moisture range may be equal to a percentage of a difference between the moisture content of the commodity and an upper bound of the target moisture range.

A difference between the lower bound of the operating temperature range and a lower bound of the target temperature range may be equal to a difference between the temperature of the commodity and an upper bound of the target temperature range.

A difference between the lower bound of the operating temperature range and a lower bound of the target temperature range may be equal to a percentage of a difference between the temperature of the commodity and an upper bound of the target temperature range.

The method may also include, responsive to a determination that the moisture content is within the target moisture range of the commodity and that the temperature of the commodity is within the target temperature range of the commodity, setting the operating moisture range for the commodity treatment device to the target moisture range of the commodity, and setting the operating temperature range for the commodity treatment device to the target temperature range of the commodity.

The method may also include, responsive to a determination that the moisture content is within or below the target range of the commodity and that the temperature of the commodity is within or below the target temperature range of the commodity, causing the commodity treatment device to be powered off, and after a selected period of time, receiving third measurement data of the commodity.

The selected period of time may be within a range of about 0.5 hour to 4 hours.

One or more embodiments include a system including a container, a commodity monitoring device at least partially disposed within the container and including a plurality of sensor nodes, a commodity treatment device disposed adjacent to or within the container, and a commodity management system in communication with the commodity monitoring device and operably coupled to the commodity treatment device. The commodity management system includes at least one processor and at least one non-transitory computer-readable storage medium storing instructions thereon that, when executed by the at least one processor, cause the commodity management system to receive an input including a target moisture range and a target temperature range of a commodity, responsive to a determination that a moisture content of the commodity is above the target moisture range of the commodity or that a temperature of the commodity is above the target temperature range of the commodity, determine at least one of an operating moisture range for the commodity treatment device to be different than the target moisture range of the commodity or an operating temperature range for the commodity treatment device to be different from the target temperature range of the commodity, and responsive to a determination that an outside moisture content falls within the operating moisture range for the commodity treatment device and that an outside temperature falls within the operating temperature range for the commodity treatment device, cause the commodity treatment device to be powered on to treat the commodity.

Causing the commodity treatment device to be powered on may include causing at least one of a fan to be powered on, a heater to be powered on, or a vent to be opened.

Determining the operating moisture range for the commodity treatment device to be different than the target moisture range of the commodity may include setting the operating moisture range to encompass lower moisture content values than the target moisture range.

Determining the operating temperature range for the commodity treatment device to be different than the target temperature range of the commodity may include setting the operating temperature range to encompass lower temperature values than the target temperature range.

The system may further include instructions that, when executed by the at least one processor, cause the commodity management system to, responsive to a determination that the moisture content is within the target moisture range of the commodity and that the temperature of the commodity is within the target temperature range of the commodity, set the operating moisture range for the commodity treatment device to the target moisture range of the commodity, and set the operating temperature range for the commodity treatment device to the target temperature range of the commodity.

The system may further include instructions that, when executed by the at least one processor, cause the commodity management system to receive measurement data of the commodity from the commodity monitoring device, the measurement data including the moisture content of the commodity and the temperature of the commodity.

Some embodiments include a method of managing a moisture content and a temperature of a commodity within a container. The method may include setting an operating moisture range for a commodity treatment device to be different than a target moisture range of the commodity, setting an operating temperature range for the commodity treatment device to different than a target temperature range of the commodity, and operating the commodity treatment device only when both a moisture content of air external to the container falls within the operating moisture range and a temperature of the air external to the container falls within the operating temperature range.

Other technical features may be readily apparent to one skilled in the art from the following figures, descriptions, and claims.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 shows a schematic representation of a commodity monitoring device having a cable assembly and sensor nodes according to one or more embodiments of the present disclosure;

FIG. 2 shows a schematic representation of a container and one or more commodity treatment devices according to one or more embodiments of the present disclosure;

FIG. 3 shows a flowchart of a method of monitoring a commodity within a container according to one or more embodiments of the disclosure; and

FIG. 4 is a schematic view of a computer device according to embodiments of the disclosure.

### DETAILED DESCRIPTION

Illustrations presented herein are not meant to be actual views of any particular storage container, commodity management system, commodity monitoring device, commodity treatment device, component, or system, but are merely idealized representations that are employed to describe embodiments of the disclosure. Additionally, elements common between figures may retain the same numerical designation for convenience and clarity.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” etc., is used for clarity and convenience in understanding the disclosure and accompanying drawings, and does not connote or depend on any specific preference or order, except where the context clearly indicates otherwise.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “and/or” includes any and all combinations of one or more of the associated listed items.

As used herein, the term “operating moisture range” refers to a range of outside environment moisture contents (e.g., specific humidities) at which the commodity treatment device (e.g., fan) may be caused to operate (e.g., power on) in order to treat conditions (e.g., affect a moisture content) of a commodity. In particular, when a measurement of outside environment air (e.g., air external to a commodity container) indicates that a moisture content of the outside air falls within the operating moisture range, the commodity treatment device may be caused to be powered on and operate.

As used herein, the term “operating temperature range” refers to a range of outside environment temperatures at which the commodity treatment device (e.g., fan) may be caused to operate (e.g., power on) in order to treat conditions (e.g., affect a temperature) of a commodity. In particular, when a measurement of outside environment air (e.g., air external to a commodity container) indicates that a temperature of a temperature of the outside environment air falls within the operating temperature range, the commodity treatment device may be caused to be powered on and operate.

Embodiments of the present disclosure include a commodity management system for treating and affecting conditions (e.g., moisture content and temperature) of a commodity (e.g., grain) within a container (e.g., grain storage bin). For example, the commodity management system may control operation of one of more commodity treatment devices such as, heaters, heater fans, exhaust fans, vents, etc. to heat and dry the commodity. The commodity management system may utilize measurements from the sensor nodes of a commodity monitoring device (e.g., cable assembly) to determine operation of the one or more commodity treatment devices. In particular, the commodity management system may utilize feedback (e.g., measurements) from the commodity to validate how the commodity management system 102 is treating the conditions of the commodity (e.g., validate how the commodity management system drying the commodity). As a non-limiting example, a user can set a target moisture value and a target temperature value of the commodity, and the commodity management system will manage operation of the one of more commodity treatment devices (i.e., if and when the commodity treatment devices are on or off) to bring the commodity to the target moisture value and the target temperature value and keep the commodity proximate or at the target moisture value and the target temperature value. In some embodiments, the user can set a target moisture range and a target temperature range instead of single values. In some embodiments, the commodity management system can target zones (e.g., portions) of the commodity within the container.

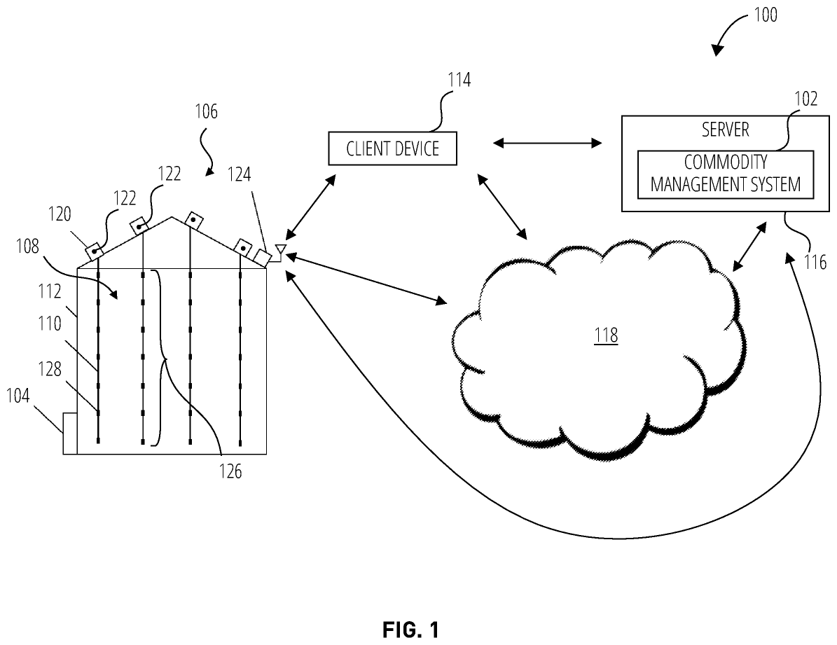

FIG. 1 shows a schematic diagram of an environment 100 in which a commodity management system 102, a commodity treatment device 104, and a commodity monitoring device 106 may be implemented and operated according to one or more embodiments of the present disclosure. The environment 100 may include the commodity monitoring device 106 at least partially disposed within the container 112 and including a cable assembly 108 having a plurality of cables 110 suspended within a container 112. The environment 100 may further include at least one client device 114, at least one server 116 including the commodity management system 102, and a network 118. The commodity management system 102, the commodity treatment device 104, the at least one client device 114, and the commodity monitoring device 106 may communicate via the network 118. Although FIG. 1 illustrates a particular arrangement of the at least one client device 114, the commodity management system 102, the commodity treatment device 104, the commodity monitoring device 106, and the network 118, various additional arrangements are possible. For example, the at least one server 116 and, accordingly, the commodity management system 102, can communicate directly with the at least one client device 114, the commodity treatment device 104, the commodity treatment device 104, and/or the commodity monitoring device 106, thereby bypassing the network 118.

The container 112 may include a grain storage bin. Furthermore, while a particular geometry is depicted in FIG. 1, it understood that the container 112 may include one or more containers of other geometries, for the same contents (e.g., grain) or other contents, with a different arrangement and/or quantity of inlet, outlet, and/or side ports.

The cable assembly 108 of the commodity monitoring device 106 may include a plurality of cables 110 coupled to and suspended from one or more top structures of a container 112. In some embodiments, one or more of the plurality of cables 110 may be coupled to a floor of the container 112 via, for instance, a floor anchor. In some embodiments, the plurality of cables 104 may each be operably coupled to and hanging from a respective cable hub 120. Each cable hub 120 may include one or more hub sensors 122 and may be in communication (e.g., via wired and/or wireless communication) with a communications gateway 124, which in turn may be in communication with the network 118, and as a result, the at least one client device 114 and/or the commodity management system 102 of the at least one server 116. The one or more hub sensors 122 may include one or more of humidity sensors, relative humidity sensors, temperature sensors, moisture sensors, and/or carbon dioxide (CO₂) sensors. The commodity monitoring device 106 may further include one or more sensors external to the container 112 (e.g., external sensors).

The commodity monitoring device 106 may be utilized to monitor conditions (e.g., moisture content, temperature, and/or carbon dioxide levels) of contents (e.g., a commodity) within the container 112. For example, each cable 110 of the cable assembly 108 may include a plurality of sensor nodes 126 coupled (e.g., secured) to the cable 110. In some embodiments, the plurality of sensor nodes 126 of each cable 110 may be spaced apart from each along a longitudinal length of the given cable 110. As a result, when a commodity (e.g., a grain) is stored within the container 112, the plurality of sensor nodes 126 of each cable 110 may be vertically distributed throughout the commodity.

The plurality of sensor nodes 126 may include one or more of humidity sensors, relative humidity sensors, temperature sensors, moisture sensors, and/or carbon dioxide (CO₂) sensors. Spacing between sensor nodes 126 of the plurality of sensor nodes 126 may be selected based on the type of sensors and/or type of commodity. Additionally, a quantity of cables 110 may be selected based at least partially on one or more of a region (e.g., climate) in which the container 112 is located, a type of commodity stored, a size of the container 112, air flow conditions within the container 112, and the types of sensors of the sensor nodes 126.

The commodity treatment device 104 may include one or more of heaters, fans, blowers, churners, vents, etc. In some embodiments, the commodity management system 102 may utilize the measurements captured by the commodity monitoring device 106 and/or measurements captured outside of the container 112 (e.g., measurements of an outside environment) to determine and control operation of the commodity treatment devices 104 of the container 112 to affect conditions of the commodity. Furthermore, while the commodity treatment device 104 is depicted in FIG. 1 as being adjacent to the container 112, the disclosure is not so limited, and the commodity treatment device 104 can be oriented relative to and/or installed on and/or in the container 112 via any conventional manner.

Referring still to FIG. 1, in some embodiments, one or more of the at least one client device 114, the commodity monitoring device 106, or the at least one commodity management system 102 may include a display for displaying data regarding measurements obtained via the commodity monitoring device 106, data regarding operation of the commodity treatment devices 104, and/or data regarding measurements of an outside environment. In some embodiments, the displayed data may include one or more parameters of commodity within the container 112. The parameters may include one or more of temperature, humidity, relative humidity, moisture content, and/or carbon dioxide.

As is described in great detail below, the commodity management system 102 may utilize measurements from the sensor nodes 126 of the commodity monitoring device 106 to affect operation of one or more commodity treatment devices 104 (e.g., fans, heaters, vents, etc.). In particular, the commodity management system 102 may utilize feedback (e.g., measurements) from the commodity to validate how the commodity management system 102 is treating conditions of the commodity (e.g., drying the commodity).

In some embodiments, a user can interface with the at least one client device 114, for example, to communicate with the at least one server 116 and to utilize the commodity management system 102 and the commodity monitoring device 106 to monitor and manage contents of the container 112. The user may include one or more operators of the container 112, the commodity monitoring device 106, and/or commodity management system 102. Although FIG. 1 shows a single client device 114, the environment 100 can include any number of client devices 114, in communication with the network 118, the commodity management system 102, the commodity treatment device 104, and/or the commodity monitoring device 106.

In some embodiments, the client device 114 may include a client application installed thereon. In one or more embodiments, the client application can be associated with the commodity management system 102. For example, the client application may allow the client device 114 to directly or indirectly interface with other elements the commodity management system 102 and/or the commodity monitoring device 106. The client application also enables a user (e.g., an operator) to initiate measurements via the commodity monitoring device 106 and observe any results of the measurements (e.g., measured temperatures, measured moisture contents, etc.). Furthermore, the client application also enables a user (e.g., an operator) to initiate operation modes of the commodity treatment device 104.

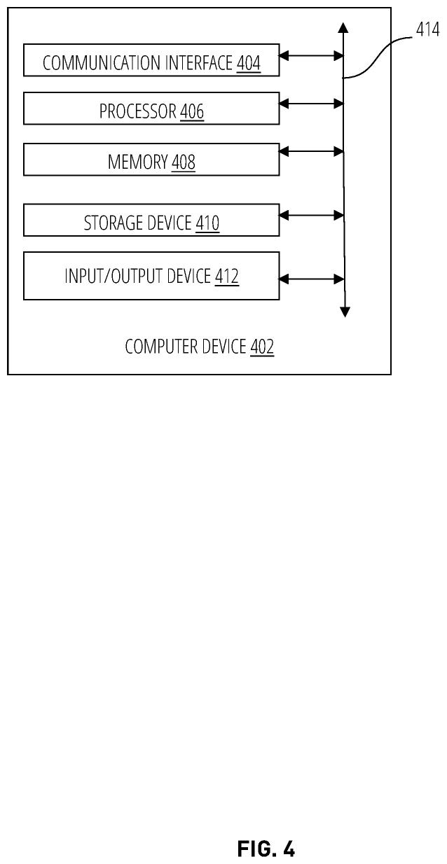

Both the at least one client device 114 and the at least one server 116 (and the commodity management system 102) can represent various types of computing devices with which operators can interact. For example, the at least one client device 114 and/or the at least one server 116 may include a mobile device (e.g., a cell phone, a smartphone, a PDA, a tablet, a laptop, a watch, a wearable device, etc.). In some embodiments, however, the at least one client device 114, and/or at least one server 116 can be a non-mobile device (e.g., a desktop or server). In some embodiments, the at least one server 116 may include a cloud computing platform and may be configured to perform processing required to implement the commodity management system 102. In one or more embodiments, the at least one server 116 may include a web server that provides a web site that can be used by operators monitoring the contents of the container 112 via a remote client device 114. Additional details with respect to the client device 114 and the server 116 are discussed below with respect to FIG. 4.

Referring still to FIG. 1, while the commodity management system 102 is depicted as being a portion of (e.g., implemented by) the server 116, the disclosure is not so limited. Rather, in some embodiments, the commodity management system 102 may be implemented at one or more of the client device 114, the commodity monitoring device 106, the cable hubs 120, or the server 116. In some embodiments, the commodity management system 102 may be implemented at a computing device that is local to the container 112 (e.g., edge computing). In some embodiments, the commodity management system 102 may be implemented at different devices of the environment 100 operating according to a primary-secondary configuration or peer-to-peer configuration. For purposes of illustration and convenience, implementation of the commodity management system 102 is described herein as being implemented by the server 116, with the understanding that functionality may be implemented in other and/or additional devices.

The network 118 may include one or more networks, such as the Internet, and can use one or more communications platforms or technologies suitable for transmitting data and/or communication signals. As a non-limiting example, the network 118 may utilize one or more of near field communication (NFC), BLUETOOTH @, wireless/cellular networks, wide area networks (WAN), LoRa, wired communications, or any other conventional network for transmitting data and/or communication signals between the commodity monitoring device 106, the client device 114, the commodity treatment device 104, and the commodity management system 102.

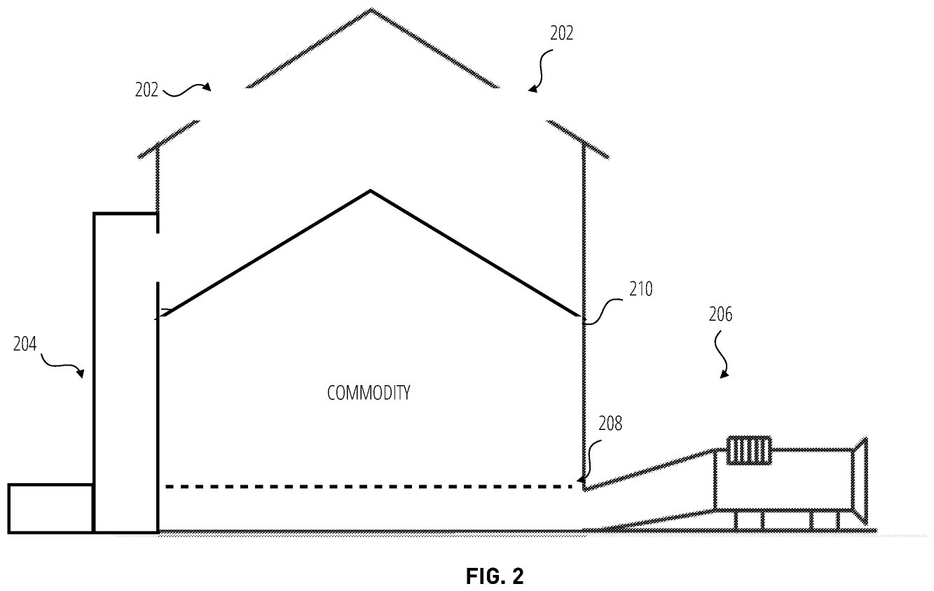

FIG. 2 is a simplified representation of the container 112 of FIG. 1 and example commodity treatment devices 104. As depicted in FIG. 2, in some embodiments, the commodity treatment devices 104 may include one or more dryer and fan systems and one or more vents 202 or exhaust fans. Furthermore, the one or more dryer and fan systems may include a top dryer and fan system 204 and/or a batch dryer and fan system 206 utilizing a perforated floor 208. In additional embodiments, the one or more dryer and fan systems may include roof dryer and fan systems and/or in-bin stirring devices.

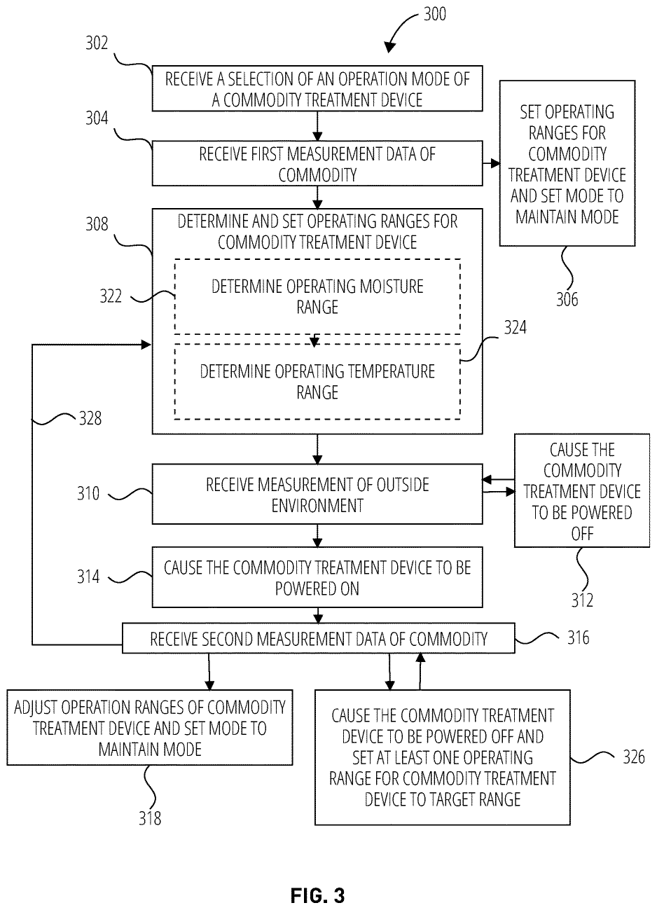

FIG. 3 shows a flowchart of a method 300 for managing a commodity (e.g., grain) within a container 112 according to one or more embodiments of the present disclosure. As shown in FIG. 3, the method 300 may include receiving a selection of an operation mode of a commodity treatment device 104, as shown in act 302. For example, the commodity management system 102 may receive the selection of the operation mode of the commodity treatment device 104. In some embodiments, the selection may be input at one or more of the client device 114 (e.g., a user device), the commodity management system 102, the commodity treatment device 104, or any other device in communication with the commodity management system 102.

In embodiments where the commodity treatment device 104 includes fans, heaters, and/or blowers, the selection of the operation mode of the commodity treatment device 104 may include a selection of a drying mode and/or a heating mode of the commodity treatment device 104. Furthermore, in one or more embodiments, the selection of a drying mode and/or a heating mode of the commodity treatment device 104 may include a selection of a type of commodity, a target commodity moisture content range (referred to hereinafter as “target moisture range”), and/or a target commodity temperature range (referred to herein as “target temperature range”). In some embodiments, a target commodity moisture content value and a target commodity temperature value may be selected instead of ranges. However, to facilitate description of the embodiments herein, a target moisture range and a target moisture range are referred to herein, but it is understood that a target moisture content value and a target moisture value may be selected instead and used interchangeably with the ranges described herein. As used herein, the target moisture range may include a target relative humidity range. Furthermore, in some embodiments, the selection of a drying mode and/or a heating mode of the commodity treatment device 104 may include a selection of sensors utilized to capture measurements of the commodity. For instance, the selection may include a selection as to whether the commodity is to be monitored via a container average (e.g., an average of measurements captured by multiple sensor nodes 126 (e.g., the cable assembly 108) within the container 112) or by one or more individual sensor nodes 126 within the commodity.

The method 300 may include, responsive to the selection of the operation mode of the commodity treatment device 104, receiving first measurement data of the commodity, as shown in act 304 of FIG. 3. For example, the commodity management system 102 may receive the first measurement data from the commodity monitoring device 106. In some embodiments, the first measurement data may reflect measurements from each of the plurality of sensor nodes 126 of the commodity monitoring device 106. In other embodiments, the first measurement data may reflect measurements from only some of the sensor nodes 126 of the plurality of sensor nodes 126 of the commodity monitoring device 106. For instance, the first measurement data may reflect measurements from only sensor nodes 126 determined to be within commodity. In yet further embodiments, the first measurement data may reflect measurements from sensor nodes 126 experiencing a highest temperature (i.e., hottest sensor nodes 126) or lowest temperature (i.e., coldest sensor nodes 126) and/or sensor nodes 126 measuring the highest moisture contents (i.e., the wettest sensor nodes 126) or lowest moisture contents (i.e., the driest sensor nodes 126). In additional embodiments, the first measurement data may also include carbon dioxide data.

In some embodiments, the first measurement data may include moisture content data (e.g., relative humidity data) of the commodity and temperature data of the commodity. The moisture content data may include relative humidity data (e.g., equilibrium relative humidity) of air within the mass of the commodity. For purposes of the present disclosure and for ease of description, the moisture content data of the first measurement data may be referred to as the moisture content of the commodity; however, it is understood that the moisture content of the commodity may refer to the relative humidity data of the air within the mass of the commodity.

In some embodiments, the first measurement data may include a current moisture content of at least one portion of the commodity and a current temperature of at least one portion of the commodity. For ease of description, the first measurement data may be described herein generally as including a current moisture content of the commodity and/or a current temperature of the commodity; however, it is understood that the first measurement data may represent only one or more portions of the commodity within the container 112 and/or portions of the first measurement data utilized to affect operation of the commodity treatment device 104 may represent only one or more portions of the commodity within the container 112.

Referring still to FIG. 3, the method 300 may include, responsive to the first measurement data reflecting a commodity moisture content and a commodity temperature being within the target moisture range (or at the target moisture content value) and within the target temperature range (or at the target temperature value), respectively, setting an operating moisture range and an operating temperature range of the commodity treatment device 104 to match the target moisture range and the target temperature range, respectively, and changing the operation mode of the commodity treatment device 104 to a maintain mode, as shown in act 306 of FIG. 3. For instance, the commodity management system 102 may set operating moisture range and the operating temperature range of the commodity treatment device 104 to match the target moisture range and the target temperature range, respectively, and may change the operation mode of the commodity treatment device 104 to a maintain mode.

As used herein, the term “maintain mode” may refer to a mode of the commodity management system 102 and commodity treatment device 104 where the commodity treatment device 104 is operated to at least substantially maintain a moisture content and/or a temperature of the commodity. In some embodiments, the maintain mode may include only operating the commodity treatment device 104 when a moisture content and/or a temperature of the commodity approaches lower or upper bounds of the associated target range of the commodity. In other words, the maintain mode may include operating the commodity treatment device 104 to keep the commodity within the target moisture range and the target temperature range.

The method 300 may further include, responsive to the first measurement data reflecting a commodity moisture content and/or a commodity temperature being above the target moisture range and/or the target temperature range, determining and setting the operating moisture range and/or the operating temperature range of the commodity treatment device 104 to be different than the target moisture range and the target temperature range, respectively, as show in act 308 of FIG. 3. In particular, the commodity management system 102 may determine and set the operating moisture range and/or the operating temperature range of the commodity treatment device 104 to be different than the target moisture range and the target temperature range, respectively.

Referring still to FIG. 3, responsive to the first measurement data reflecting a current commodity moisture content above the target moisture range, act 308 may include determining the operating moisture range for the commodity treatment device 104 to be different than the target moisture range, as shown in act 322. In particular, the commodity management system 102 may set the operating moisture range to be different than the target moisture range. In some embodiments, determining the operating moisture range for the commodity treatment device 104 may include setting a lower bound (i.e., minimum value) of the operating moisture range to be lower than a lower bound (i.e., minimum value) of the target moisture range (or lower than the target moisture content value) and setting an upper bound (i.e., maximum value) of the operating moisture range to be equal to the commodity moisture content reflected in the first measurement data.

In some embodiments, the lower bound (i.e., minimum value) of the determined operating moisture range may be dependent on a difference between the current commodity moisture content and an upper bound of the target moisture range. In some embodiments, the lower bound (i.e., minimum value) of the determined operating moisture range may be dependent on a difference between the current commodity moisture content and the target moisture content value. For example, the larger the difference, the lower the lower bound of the operating moisture range will be. In some embodiments, a difference between the lower bound of the operating moisture range and a lower bound of the target moisture range may be set as equal to the difference between current commodity moisture content and an upper bound of the target moisture range. In additional embodiments, a difference between the lower bound of the operating moisture range and a lower bound of the target moisture range may be set as a percentage of the difference between current commodity moisture content and an upper bound of the target moisture range. In some embodiments, the percentage may be 90%, 80%, 70%, 50%, 30%, or 25% of the difference between current commodity moisture content and an upper bound of the target moisture range.

Referring still to FIG. 3, responsive to the first measurement data reflecting a commodity temperature above the target temperature range, act 308 may include determining the operating temperature range of the commodity treatment device 104 to be different than the target temperature range, as shown in act 324. In particular, the commodity management system 102 may set the operating temperature range to be different than the target temperature range. In some embodiments, determining the operating temperature range of the commodity treatment device 104 may include setting a lower bound (i.e., minimum value) of the operating temperature range to be lower than a lower bound (i.e., minimum value) of the target temperature range and setting an upper bound (i.e., maximum value) of the operating temperature range to be equal to the commodity temperature content reflected in the first measurement data.

In some embodiments, the lower bound (i.e., minimum value) of the operating temperature range may be dependent on a difference between current commodity temperature and an upper bound of the target temperature range. In some embodiments, the lower bound (i.e., minimum value) of the operating temperature range may be dependent on a difference between current commodity temperature and the target temperature value. For example, the larger the difference, the lower the lower bound of the operating temperature range will be. In some embodiments, a difference between the lower bound of the operating temperature range and a lower bound of the target temperature range may be set as equal to the difference between current commodity temperature and an upper bound of the target temperature range. In additional embodiments, a difference between the lower bound of the operating temperature range and a lower bound of the target temperature range may be set as a percentage of the difference between current commodity temperature and an upper bound of the target temperature range. In some embodiments, the percentage may be 90%, 80%, 70%, 50%, 30%, or 25% of the difference between current commodity temperature and an upper bound of the target temperature range.

Referring still to act 308 of FIG. 3, in some embodiments, only one of the operating moisture range or the operating temperature range may be set as different than the associated target range of the commodity. For example, in some instances, only one of the current commodity moisture content or the current commodity temperature may be above the associated target range of the commodity, and the other of the current commodity moisture content or the current commodity temperature may be within the associated target range of the commodity. In such instances, one of the operating moisture range or the operating temperature range may be set as different than the associated target range, and the other of the operating moisture range or the operating temperature range may be set as the associated target range.

Responsive to setting the operating ranges (i.e., the operating moisture range and the operating temperature range) for the commodity treatment device 104, the method 300 may include receiving measurement data of an outside environment, as shown in act 310 of FIG. 3. For example, the commodity management system 102 may receive the measurement data of the outside environment. In some embodiments, the commodity management system 102 may receive the measurement data of the outside environment from one or more of a hub sensor 122, a sensor proximate or at the gateway 124, a sensor within the commodity treatment device 104, the external sensors, and/or any other sensor exposed to the outside environment. In some embodiments, the measurement data may include outside moisture content data and/or outside temperature data. In one or more embodiments, the outside moisture content data may include a measurement of specific humidity of the outside air.

In some embodiments, the outside moisture content data and/or the outside temperature data may be adjusted (e.g., corrected) based on measurements acquired from a plenum of the commodity treatment device 104 (e.g., a supply plenum of a fan and/or heater). For example, when the commodity treatment device 104 is operated, a temperature and a moisture content of the air passed through the commodity treatment device 104 is changed due to increased pressure within the commodity treatment device 104. Accordingly, an estimated correction value is applied to the outside moisture content data and/or the outside temperature data to compensate for the change due to increased pressure.

The method 300 may further include, responsive to a determination that the outside moisture content and/or the outside temperature are outside of the associated operating ranges (e.g., the operating moisture range and the operating temperature range) for the commodity treatment device 104, causing the commodity treatment device 104 to be powered off or leaving the commodity treatment device 104 powered off, as shown in act 312. Furthermore, the method 300 may further include repeating act 310 and act 312 and receiving outside measurements until both the outside moisture content and the outside temperature are within the associated operating ranges (e.g., the operating moisture range and the operating temperature range) for the commodity treatment device 104.

Responsive to a determination that both the outside moisture content and the outside temperature are within the associated operating ranges (e.g., the operating moisture range and the operating temperature range) for the commodity treatment device 104, the method 300 may include causing the commodity treatment device 104 to be powered on, as shown in act 314 of FIG. 3. For example, the commodity management system 102 may cause the commodity treatment device 104 to be powered on. In some embodiments, powering on the commodity treatment device 104 may include one or more of powering on one or more fans, powering on one or more heaters, and/or opening one or more vents.

Additionally, after causing the commodity treatment device 104 to be powered on, the method 300 may include receiving second measurement data of the commodity, as shown in act 316 of FIG. 3. For example, the commodity management system 102 may receive the second measurement data of the commodity. In some embodiments, the second measurement data may reflect measurements from each of the plurality of sensor nodes 126 of the commodity monitoring device 106. In other embodiments, the second measurement data may reflect measurements from only some of the sensor nodes 126 of the plurality of sensor nodes 126 of the commodity monitoring device 106. For instance, the second measurement data may reflect measurements from only sensor nodes 126 determined to be within commodity. In yet further embodiments, the second measurement data may reflect measurements from sensor nodes 126 experiencing a highest temperature (i.e., hottest sensor nodes 126) or lowest temperature (i.e., coldest sensor nodes 126) and/or sensor nodes 126 measuring the highest moisture contents (i.e., the wettest sensor nodes 126) or lowest moisture contents (i.e., the driest sensor nodes 126). In some embodiments, the second measurement data may be acquired via the same sensor nodes 126 that captured the first measurement data. Furthermore, the second measurement data may include any of the types of data (e.g., moisture content data, temperature data, or carbon dioxide data) that the first measurement data included.

In some embodiments, the second measurement data may be received after a selected period of time subsequent to causing the commodity treatment device 104 to be powered on. In one or more embodiments, the selected period of time may be about 30 minutes, 1 hour, 2 hours, 5 hours, 12 hours, 24 hours, or any other period of time. For example, the method 300 may include permitting the commodity to be treated by the commodity treatment device 104 for at least some time prior to receiving the second measurement data.

Referring still to FIG. 3, the method 300 may include, responsive to the second measurement data reflecting a commodity moisture content and a commodity temperature being within the target moisture range and the target temperature range, respectively, adjusting the operating moisture range and the operating temperature range for the commodity treatment device 104 to match the target moisture range and the target temperature range, respectively, and changing the operation mode of the commodity treatment device 104 to the maintain mode, as shown in act 318 of FIG. 3. For example, the commodity management system 102 may adjust the operating moisture range and the operating temperature range of the commodity treatment device 104 to match the target moisture range and the target temperature range, respectively, and change the operation mode of the commodity treatment device 104 to the maintain mode. In some embodiments, at least two consecutive measurements reflecting a commodity moisture content and a commodity temperature being within the target moisture range and the target temperature range are required in order to perform act 318. For example, in some embodiments, the method 300 may include performing act 326 (described below) after a first measurement reflecting a commodity moisture content and a commodity temperature being within the target moisture range and the target temperature range.

In particular, the method 300 may include, responsive to the second measurement data reflecting a commodity moisture content and/or a commodity temperature being within or below the target moisture range and/or the target temperature range, causing the commodity treatment device 104 to be powered off and setting a lower bound of at least one of the operating ranges for the commodity treatment device 104 to match the lower bound of the associated target range, as shown in act 326 of FIG. 3. For example, the commodity management system 102 may cause the commodity treatment device 104 to be powered off and may set a lower bound of at least one of the operating ranges for the commodity treatment device 104 to match the lower bound of the associated target range.

Referring still to act 326, the method 300 may include waiting for a selected period of time prior to returning to and repeating act 316 and receiving a third measurement data of the commodity. Waiting for a selected period of time enables the sensor nodes 126 utilized to capture the second measurement to reach an equilibrium with the commodity. As a result, repeating act 316 after waiting the selected period of time may yield a more accurate measurement of the moisture content and temperature of the commodity. Referring to acts 316 and 318 together, in some embodiments, the method 300 may require at least one measurement taken after waiting the selected period of time prior to adjusting the operating moisture range and the operating temperature range for the commodity treatment device 104 to match the target moisture range and the target temperature range and changing the operation mode of the commodity treatment device 104 to the maintain mode. In some embodiments, the selected period of time may include 30 minutes (0.5 hour), 1 hour, 2 hours, or longer.

Conversely, responsive to the second measurement data reflecting a commodity moisture content and/or a commodity temperature being above the target moisture range and/or the target temperature range, the method 300 may include, returning to act 308 of FIG. 3 and repeating act 308 through act 314 based on the second measurement data, as shows in act 328 of FIG. 3.

Referring to FIG. 1 through FIG. 3 together, the commodity management system 102 and methods described herein may provide advantages over conventional commodity management devices and related methods. For example, by utilizing direct feedback from the commodity and permitting operating ranges of the commodity treatment devices to reflect ranges outside of target ranges of the commodity, treatment by the may be commodity treatment devices more effective and quicker than conventional methods. Moreover, utilizing direct feedback from the commodity in operating the commodity treatment devices may reduce overheating and/or over-drying of the commodity in comparison to conventional methods. Likewise, utilizing direct feedback from the commodity in operating the commodity treatment devices may reduce spoilage resulting from wet and/or hot spots within the commodity in comparison to conventional methods.

FIG. 4 is a schematic view of a computer device 402. In some embodiments, one or more of the commodity treatment device 104, the commodity management system 102, the client device 114, and/or the server 116 may include a computer device such as the computer device 402 of FIG. 4. The computer device 402 may include a communication interface 404, a processor 406, a memory 408, a storage device 410, an input/output device 412, and a bus 414.

In some embodiments, the processor 406 includes hardware for executing instructions, such as those making up a computer program. As an example, and not by way of limitation, to execute instructions, the processor 406 may retrieve (or fetch) the instructions from an internal register, an internal cache, the memory 408, or the storage device 410 and decode and execute them. In some embodiments, the processor 406 may include one or more internal caches for data, instructions, or addresses. As an example, and not by way of limitation, the processor 406 may include one or more instruction caches, one or more data caches, and one or more translation look aside buffers (TLBs). Instructions in the instruction caches may be copies of instructions in the memory 408 or the storage device 410.

The memory 408 may be coupled to the processor 406. The memory 408 may be used for storing data, metadata, and programs for execution by the processor(s). The memory 408 may include one or more of volatile and non-volatile memories, such as Random-Access Memory (“RAM”), Read-Only Memory (“ROM”), a solid state disk (“SSD”), Flash, Phase Change Memory (“PCM”), or other types of data storage. The memory 408 may be internal or distributed memory.

The storage device 410 may include storage for storing data or instructions. As an example, and not by way of limitation, storage device 410 can comprise a non-transitory storage medium described above. The storage device 410 may include a hard disk drive (HDD), Flash memory, an optical disc, a magneto-optical disc, magnetic tape, or a Universal Serial Bus (USB) drive or a combination of two or more of these. The storage device 410 may include removable or non-removable (or fixed) media, where appropriate. The storage device 410 may be internal or external to the computing storage device 410. In one or more embodiments, the storage device 410 is non-volatile, solid-state memory. In other embodiments, the storage device 410 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The input/output device 412 may allow an operator of the commodity management system 102 to provide input to, receive output from, and otherwise transfer data to and receive data from computer device 402. The input/output device 412 may include a mouse, a keypad or a keyboard, a joystick, a touch screen, a camera, an optical scanner, network interface, modem, other known I/O devices, or a combination of such I/O interfaces. The input/output device 412 may include one or more devices for presenting output to an operator, including, but not limited to, a graphics engine, a display (e.g., a display screen), one or more output drivers (e.g., display drivers), one or more audio speakers, and one or more audio drivers. In certain embodiments, the input/output device 412 is configured to provide graphical data to a display for presentation to an operator. The graphical data may be representative of one or more graphical user interfaces and/or any other graphical content as may serve a particular implementation. As is described above, the computer device 402 and the input/output device 412 may be utilized to display data (e.g., images and/or video data) regarding the contents of the container 112.

The communication interface 404 can include hardware, software, or both. The communication interface 404 may provide one or more interfaces for communication (such as, for example, packet-based communication) between the computer device 402 and one or more other computing devices or networks (e.g., a server). As an example, and not by way of limitation, the communication interface 404 may include a network interface controller (NIC) or network adapter for communicating with an Ethernet or other wire-based network or a wireless NIC (WNIC) or wireless adapter for communicating with a wireless network, such as a WI-FI.

In some embodiments, the bus 414 (e.g., a Controller Area Network (CAN) bus) may include hardware, software, or both that couples components of computer device 402 to each other and to external components.

All references cited herein are incorporated herein in their entireties. If there is a conflict between definitions herein and in an incorporated reference, the definition herein shall control.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

1. A method of managing a commodity within a container, the method comprising:
receiving first measurement data of the commodity;
based at least partially on the first measurement data:
determining whether a moisture content of the commodity is within a target moisture range of the commodity; and
determining whether a temperature of the commodity is within a target temperature range of the commodity;
responsive to a determination that the moisture content of the commodity is above the target moisture range of the commodity or that the temperature of the commodity is above the target temperature range of the commodity, determining at least one of an operating moisture range for a commodity treatment device to be different than the target moisture range of the commodity or an operating temperature range for the commodity treatment device to be different from the target temperature range of the commodity;
receiving measurement data of an outside environment; and
responsive to a determination that an outside moisture content falls within the operating moisture range for the commodity treatment device and that an outside temperature falls within the operating temperature range for the commodity treatment device, causing the commodity treatment device to be powered on to treat the commodity.

2. The method of claim 1, wherein causing the commodity treatment device to be powered on comprises causing at least one of a fan or a heater to be powered on.

3. The method of claim 1, wherein causing the commodity treatment device to be powered on comprises causing at least one vent to be opened.

4. The method of claim 1, wherein determining the operating moisture range for the commodity treatment device to be different than the target moisture range of the commodity comprises:
setting a lower bound of the operating moisture range to be lower than a lower bound of the target moisture range; and
setting an upper bound of the operating moisture range to be equal to the moisture content of the commodity.

5. The method of claim 1, wherein determining the operating temperature range for the commodity treatment device to be different than the target temperature range of the commodity comprises:
setting a lower bound of the operating temperature range to be lower than a lower bound of the target temperature range; and
setting an upper bound of the operating temperature range to be equal to the temperature of the commodity.

6. The method of claim 4, wherein a difference between the lower bound of the operating moisture range and the lower bound of the target moisture range is equal to a percentage of a difference between the moisture content of the commodity and an upper bound of the target moisture range.

7. The method of claim 4, wherein a difference between the lower bound of the operating temperature range and a lower bound of the target temperature range is equal to a difference between the temperature of the commodity and an upper bound of the target temperature range.

8. The method of claim 4, wherein a difference between the lower bound of the operating temperature range and a lower bound of the target temperature range is equal to a percentage of a difference between the temperature of the commodity and an upper bound of the target temperature range.

9. The method of claim 1, further comprising:
receiving second measurement data of the commodity;
based at least partially on the second measurement data:
determining whether the moisture content of the commodity is within the target moisture range of the commodity; and
determining whether the temperature of the commodity is within the target temperature range of the commodity.

10. The method of claim 9, further comprising:
responsive to a determination that the moisture content is within the target moisture range of the commodity and that the temperature of the commodity is within the target temperature range of the commodity:
setting the operating moisture range for the commodity treatment device to the target moisture range of the commodity; and
setting the operating temperature range for the commodity treatment device to the target temperature range of the commodity.

11. The method of claim 9, further comprising:
responsive to a determination that the moisture content is within or below the target range of the commodity and that the temperature of the commodity is within or below the target temperature range of the commodity:
causing the commodity treatment device to be powered off; and
after a selected period of time, receiving third measurement data of the commodity.

12. The method of claim 11, wherein the selected period of time is within a range of about 0.5 hour to 4 hours.

13. The method of claim 1, further comprising receiving the target moisture range and the target temperature range via a user input.

14. A system, comprising:
a container;
a commodity monitoring device at least partially disposed within the container and comprising a plurality of sensor nodes;
a commodity treatment device disposed adjacent to or within the container;
a commodity management system in communication with the commodity monitoring device and operably coupled to the commodity treatment device and comprising:
at least one processor; and
at least one non-transitory computer-readable storage medium storing instructions thereon that, when executed by the at least one processor, cause the commodity management system to:
receive an input comprising a target moisture range and a target temperature range of a commodity;
responsive to a determination that a moisture content of the commodity is above the target moisture range of the commodity or that a temperature of the commodity is above the target temperature range of the commodity, determine at least one of an operating moisture range for the commodity treatment device to be different than the target moisture range of the commodity or an operating temperature range for the commodity treatment device to be different from the target temperature range of the commodity; and
responsive to a determination that an outside moisture content falls within the operating moisture range for the commodity treatment device and that an outside temperature falls within the operating temperature range for the commodity treatment device, cause the commodity treatment device to be powered on to treat the commodity.

15. The system of claim 14, wherein causing the commodity treatment device to be powered on comprises causing at least one of a fan to be powered on, a heater to be powered on, or a vent to be opened.

16. The system of claim 14, wherein determining the operating moisture range for the commodity treatment device to be different than the target moisture range of the commodity comprises setting the operating moisture range to encompass lower moisture content values than the target moisture range.

17. The system of claim 14, wherein determining the operating temperature range for the commodity treatment device to be different than the target temperature range of the commodity comprises setting the operating temperature range to encompass lower temperature values than the target temperature range.

18. The system of claim 14, further comprising instructions that, when executed by the at least one processor, cause the commodity management system to:
responsive to a determination that the moisture content is within the target moisture range of the commodity and that the temperature of the commodity is within the target temperature range of the commodity:
set the operating moisture range for the commodity treatment device to the target moisture range of the commodity; and
set the operating temperature range for the commodity treatment device to the target temperature range of the commodity.

19. The system of claim 14, further comprising instructions that, when executed by the at least one processor, cause the commodity management system to:
receive measurement data of the commodity from the commodity monitoring device, the measurement data comprising the moisture content of the commodity and the temperature of the commodity.

20. A method of managing a moisture content and a temperature of a commodity within a container, the method comprising:
setting an operating moisture range for a commodity treatment device to be different than a target moisture range of the commodity;
setting an operating temperature range for the commodity treatment device to different than a target temperature range of the commodity; and
operating the commodity treatment device only when both a moisture content of air external to the container falls within the operating moisture range and a temperature of the air external to the container falls within the operating temperature range.
